(19) United States
(12) Patent Application Publication
(10) Pub. No.: US 2019/0331959 A1
(43) Pub. Date: Oct. 31, 2019

(54) SEGMENTED ACTIVE DIMMABLE LENS WITH RADIANT TRANSITION PATTERN

(71) Applicant: VISTEON GLOBAL TECHNOLOGIES, INC., Van Buren Township, MI (US)

(72) Inventors: Paul Fredrick Luther Weindorf, Novi, MI (US); Qais Sharif, Northville, MI (US)

(73) Assignee: VISTEON GLOBAL TECHNOLOGIES, INC., Van Buren Township, MI (US)

(21) Appl. No.: 16/394,574

(22) Filed: Apr. 25, 2019

Related U.S. Application Data
(60) Provisional application No. 62/662,429, filed on Apr. 25, 2018.

(51) Int. Cl. G02F 1/1335; G02F 1/1333; G02F 1/137; B60K 35/00; G06F 3/044

(52) U.S. Cl. CPC G02F 1/133526; G02F 1/133512; G02F 1/133502; G02F 1/133528; G02F 1/13338; G02F 1/137; B60K 2370/349; G06F 3/044; G02F 2202/28; B60K 2370/1438; B60K 2370/25; B60K 2370/37; B60K 35/00

(57) ABSTRACT

A display system including a display, a cover layer, an active cell, an opaque print, an adhesive film and an anti-reflective film. The display may generate an optical signal. The cover layer may cover the display and has a first and second surface. The optical signal may pass through the second surface and out the first surface. The active cell may be adjacent to the second surface and includes conductive planes configured to vary a transmission of the optical signal in response to a signal. The opaque print may be adjacent the active cell and has a clear area aligned with the display. The clear area may be smaller than the display. The adhesive film may be adjacent to the active cell, aligned with the clear area, and transmits the optical signal. The anti-reflective film may be attached to the adhesive film and receives the optical signal from the display.

### CROSS REFERENCE TO RELATED APPLICATIONS

This application claims the benefit of U.S. Provisional Patent Application No. 62/662,429, filed on Apr. 25, 2018, and entitled “SEGMENTED ACTIVE DIMMABLE LENS WITH RADIANT TRANSITION PATTERN,” which is incorporated by reference in its entirety in this disclosure.

### TECHNICAL FIELD

The present disclosure generally relates to visibility of electronic displays, and in particular to a segmented active dimmable lens covering the displays.

### BACKGROUND

As electronic displays are utilized increasingly in automotive instrument clusters, original equipment manufacturers seek to hide the display opening and present a “seamless” appearance to the user such that the user cannot see any apertures or margin gaps around the display. The seamless lens hides the location of the display in an unlit condition, often referred to as a “dead front”, “secret until lit”, “black panel” or “dark panel” effect. In addition, the original equipment manufacturers seek to minimize an appearance of the rectangular display opening in an “on” condition caused by a back-luminance leakage of the display. Organic light emitting diode displays minimize the “on” condition leakage. However, the organic light emitting diode displays do not have sufficient luminance capability to utilize a neutral density film in front of the displays to generate a seamless dark panel effect.

### SUMMARY

This section provides a general summary of the disclosure and is not a comprehensive disclosure of its full scope or all of its features, aspects or objectives.

A display system is provided herein. The display system includes a display for generating an optical signal. The display system may include a cover layer covering the display. The cover layer may include a first surface and a second surface opposite the first surface. The cover layer may pass the optical signal through the second surface and out of the first surface. The display system may include an active cell that is adjacent to the second surface of the cover layer. The active cell generally includes a plurality of conductive planes. The active cell may vary a transmission of the optical signal through the active cell in response to a brightness signal applied to the plurality of conductive planes. The display system may include an opaque print that is adjacent to the active cell and opposite the cover layer. The opaque print may include a clear area that is aligned with the display. The clear area may have a size smaller than the display. The display system generally includes an adhesive film that is adjacent to the active cell and opposite the cover layer. The adhesive film may be aligned with the clear area. The adhesive film may be transparent to transmit the optical signal. The display system may include an anti-reflective film attached to the adhesive film. The anti-reflective film may receive the optical signal from the display.

In the display system, the opaque print may include an opaque area surrounding the clear area. The opaque print may include a fade pattern between the opaque area and the clear area. The fade pattern may serve as a transition between the opaque area and the clear area. The fade pattern may include a dot pattern. For example, the dot pattern may include columns of dots. A column may include a first dot proximal to the opaque area and distal the clear area and a second dot proximal to the clear area and distal to the opaque area. The first dot may have a dimension that is greater than the second dot. In a column, the size of the dots may taper the size of the dots from a greatest size being proximal to the opaque area to a smallest size being proximal to the clear area. The fade pattern, such as for the dot pattern, may include a sinusoidal pattern or half-sinusoidal pattern.

An active dimmable lens is provided herein. The active dimmable lens may include a cover layer, an active cell, an opaque print, an adhesive film and an anti-reflective film. The cover layer may be configured to cover a display. The cover layer may have a first surface and a second surface opposing the first surface, and an optical signal generated by the display enters the cover layer through the second surface and exits through the first surface. The active cell may be adjacent to the second surface of the cover layer. The active cell may include a plurality of conductive planes, and a transmission of the optical signal through the active cell is variable in response to a brightness signal applied to the conductive planes.

The opaque print may be adjacent the active cell opposite the cover layer. The opaque print may have a clear area alignable with the display, and the clear area has a size smaller than the display. The adhesive film may be adjacent to the active cell opposite the cover layer. The adhesive film may be aligned with the clear area, and the adhesive film may be transparent to the optical signal. The anti-reflective film may be attached to the adhesive film and configured to receive the optical signal from the display.

An active dimmable lens is provided herein. The active dimmable lens may include a cover layer, an active cell, an opaque print, a plurality of adhesive films and a plurality of anti-reflective films. The cover layer may be configured to cover a plurality of displays. The cover layer may have a first surface and a second surface opposing the first surface, and a plurality of optical signals generated by the plurality of displays enter the cover layer through the second surface and exit through the first surface. The active cell may be adjacent to the second surface of the cover layer. The active cell may include a plurality of conductive planes, the conductive planes may include a plurality of segments, the plurality of segments may be aligned with the plurality of displays, and a plurality of transmissions of the plurality of optical signals through the plurality of segments are independently variable in response to a plurality of brightness signals applied to the plurality of segments.

The opaque print may be adjacent the active cell on the side opposite the cover layer. The opaque print may have a plurality of clear areas aligned with the plurality of displays, and the plurality of clear areas have a plurality of sizes smaller than the plurality of displays. The plurality of adhesive films may be adjacent to the active cell opposite the cover layer. The plurality of adhesive films may be aligned with the plurality of clear areas, and the plurality of adhesive films are transparent to the plurality of optical signals. The plurality of anti-reflective films may be attached to the plurality of adhesive films and configured to receive the plurality of optical signals from the plurality of displays.

An active dimmable lens is provided herein. The active dimmable lens may include a cover layer, an active cell, a touch sensor, an opaque print and adhesive film and an anti-reflective film. The cover layer may be configured to cover a display. The cover layer may have a first surface and a second surface opposing the first surface The display may be configured to generate an optical signal. The cover layer may be configured to pass the optical signal through the second surface and out of the first surface. The active cell may be adjacent to the second surface of the cover layer. The active cell may include a plurality of conductive planes. The active cell may be configured to vary a transmission of the optical signal through the active cell in response to a brightness signal applied to the plurality of conductive planes. The touch sensor may be disposed on a side of the active cell opposite the display.

The opaque print may be adjacent the active cell on the side opposite the cover layer. The opaque print may have a clear area aligned with the display, and the clear area has a size smaller than the display. The adhesive film may be adjacent to the active cell opposite the cover layer. The adhesive film may be aligned with the clear area, and the adhesive film is optically transparent to transmit the optical signal through the adhesive film. The anti-reflective film may be attached to the adhesive film and configured to receive the optical signal from the display.

Further objects, features and advantages of this disclosure will become readily apparent to persons skilled in the art after a review of the following description, with reference to the drawings and claims that are appended to and form a part of this specification.

### BRIEF DESCRIPTION OF THE DRAWINGS

FIG. 1 illustrates a context of a platform.

FIG. 2 illustrates a schematic diagram of an implementation of a console display in accordance with one or more embodiments.

FIG. 3 illustrates a schematic diagram of an implementation of another console display in accordance with one or more embodiments.

FIG. 4 illustrates a schematic diagram of a neutral density element reflection diagram in accordance with one or more embodiments.

FIG. 5 illustrates a schematic diagram of an anti-reflection film applied to a rear surface of the film in accordance with one or more embodiments.

FIG. 6 illustrates a schematic diagram without the anti-reflection film applied to the rear surface of the film in accordance with one or more embodiments.

FIG. 7 illustrates a schematic diagram of a fade pattern in a corner of a clear area of an opaque print in accordance with one or more embodiments.

FIG. 8 illustrates a schematic diagram of a half-sinusoidal transmission fade pattern in accordance with one or more embodiments.

FIG. 9 illustrates a schematic diagram of a sinusoidal spatial fade pattern in accordance with one or more embodiments.

FIG. 10 illustrates a schematic diagram of a conductive plane fade pattern in accordance with one or more embodiments.

FIG. 11 illustrates a schematic diagram of a corner fade patter in accordance with one or more embodiments.

FIG. 12 illustrates a schematic diagram of an active dimmable lens incorporating a touch sensor in a baseline configuration in accordance with one or more embodiments.

FIG. 13 illustrates a schematic diagram of an active dimmable lens with the linear polarizer on the first surface of the cover layer in accordance with one or more embodiments.

FIG. 14 illustrates a schematic diagram of an active dimmable lens with no cover layer in accordance with one or more embodiments.

FIG. 15 illustrates a schematic diagram of an active dimmable lens with the linear polarizer behind the touch sensor in accordance with one or more embodiments.

FIG. 16 illustrates a schematic diagram of an active dimmable lens with the linear polarizer between the active polarizer and the display in accordance with one or more embodiments.

FIG. 17 illustrates a schematic diagram of an active dimmable lens with no linear polarizer and no cover layer in accordance with one or more embodiments.

FIG. 18 illustrates a schematic diagram of an active dimmable lens with no linear polarizer in accordance with one or more embodiments.

FIG. 19 illustrates a schematic diagram of an active dimmable lens with a shaped configuration in accordance with one or more embodiments.

### DETAILED DESCRIPTION

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

Embodiments may an active dimmable lens to be placed over one or more displays in a vehicle. The active dimmable lens generally has an optical configuration that offers a seamless appearance where display apertures are less visible in an “off” condition and minimized in an “on” condition. Active segmented liquid crystal technologies may be utilized together with a gradient transition pattern to foster a seamless appearance.

The active dimmable lens may include a cover layer. One or more optical signals generated by the displays may pass through the cover layer to one or more people (or users). An anti-glare layer may be applied to the cover layer on a side seen by the people.

An active cell disposed between the displays and the cover layer. The active cell generally includes two counter opposing conductive planes. In some embodiments, the active cell may be implemented as an active polarizing cell. In other embodiments, the active cell may be implemented as an electronic tint cell. The conductive planes may be divided into one or more segments, at least one segment for each display. Transmission of the optical signals through the active cell may be variable in response to brightness signals applied to the segments.

A touch sensor may be disposed on a side of the active cell opposite the plurality of displays. The touch sensor may be configured to receive commands from the people based on menus and/or icons presented on the displays.

An opaque print (e.g., black paint) may be created adjacent the active cell on a side opposite the cover layer. The opaque print may have one or more clear area alignable with the displays. The clear areas generally have sizes smaller than that of the respective displays. The clear areas allow the people to see the display while the opaque print hides the apertures or margin gaps around the displays.

One or more adhesive films may be applied adjacent to the active cell on the display side. The adhesive films may be aligned with the clear areas and may be transparent to the optical signals. One or more anti-reflective films may be attached to the adhesive films. The anti-reflective films may receive the optical signals from the displays. Additional anti-reflective films may be applied over an active side of the displays.

In embodiments incorporating an active polarize cell, a linear polarizer may be disposed between the cover layer and the active polarizer cell. The optical signals passing through the active dimmable lens may be optically attenuated by the linear polarizer in response to degrees of optical polarization created by the segments in the active cell.

For styling reasons, the display areas may be hidden in a power-off condition (e.g., vehicle key in the off position). While the vehicle is off, the active dimmable lens may be configured to be in the low transmission (e.g., dark) state. After the vehicle is started, the transmission of the active dimmable lens may be automatically adjusted (e.g., brightened) for proper display visibility with an objective to keep the active dimmable lens as dark as possible. The use of the active cell in conjunction with the linear polarizer generally offers a solution towards providing a “dead front” appearance while minimizing display backlighting power.

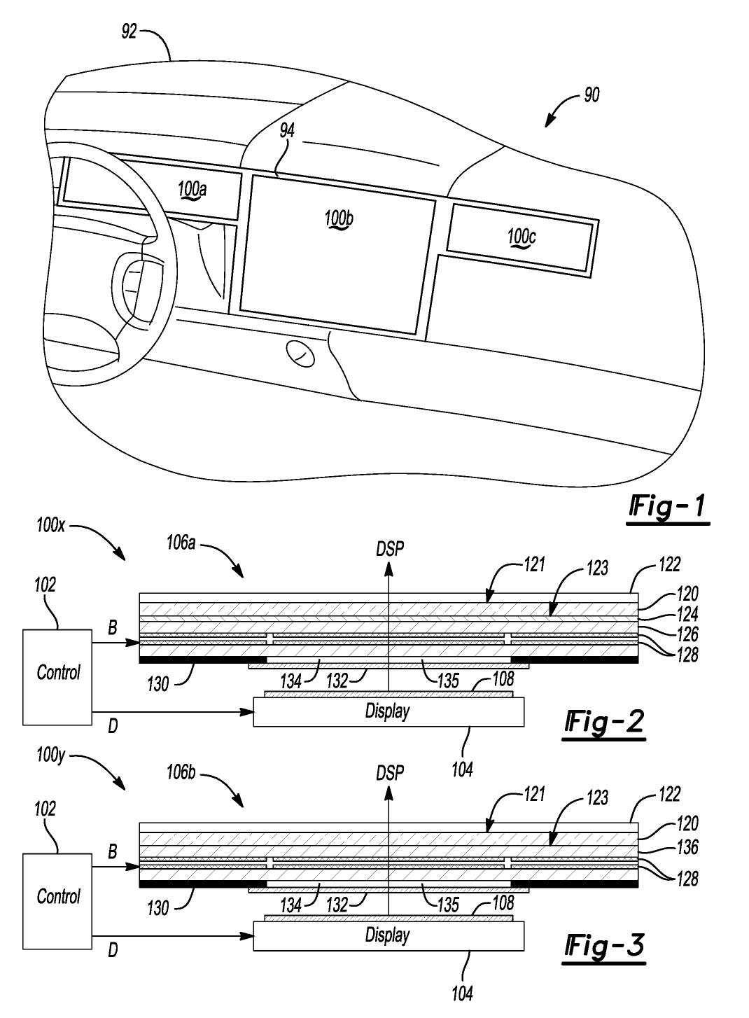

FIG. 1 illustrates a context of a platform 90. The platform 90 generally includes a body 92 and a cross cockpit display console 94. The cross cockpit display console 94 generally includes multiple console displays 100a-100c. The body 92 may implement a body of a vehicle. The vehicle may include mobile vehicles such as automobiles, trucks, motorcycles, boats, trains and/or aircraft. In some embodiments, the body 92 may be part of a stationary object. The stationary objects may include, but are not limited to, billboards, kiosks and/or marquees. Other types of platforms 90 may be implemented to meet the design criteria of a particular application.

The cross cockpit display console 94 may extend across a console area of the vehicle. The cross cockpit display console 94 may include an instrument panel console (e.g., the console display 100a), a center console (e.g., the console display 100b) and a passenger console (e.g., the console display 100c). Other numbers of console displays 100a-100c and/or other locations of the console displays 100a-100c may be implemented to meet the design criteria of a particular application.

The console displays 100a-100c are generally mounted to the body 92. In various embodiments, all console displays 100a-100c may be dimmed uniformly and simultaneously by the active dimmable lens. In other embodiments, each console display 100a-100c may be dimmed/brightened independently of the other console displays 100a-100c by a segmented active dimmable lens.

FIG. 2 illustrates a schematic diagram of an implementation of a console display 100x in accordance with one or more embodiments. In some embodiments, the console display 100x may be representative of the console displays 100a-100c. The console display 100x generally comprises a control circuit 102, a display 104, an active dimmable lens 106a and a smooth anti-reflection film 108. The active dimmable lens 106a may be positioned before the display 104. The active dimmable lens 106a and the display 104 may be electrically connected to the control circuit 102.

The active dimmable lens 106a generally comprises a cover layer (or lens) 120, an anti-glare film 122, a linear polarizer 124, an active polarizer cell (or active cell) 126, two counter opposing conductive planes 128 within the active polarizer cell 126, an opaque print 130, an anti-reflection film 132, and an adhesive film 134.

An optical signal (e.g., DSP) may be generated by the display 104 and transmitted through the active dimmable lens 106a. The optical signal DSP may be an optical signal that carries multiple visible images. The visible images may include words, numbers, pictures, graphical shapes, video and information related to the platform 90 (e.g., radio, entertainment, climate control, etc.).

A display signal (e.g., D) may be generated by the control circuit 102 and received by the display 104. The display signal D may carry information used by the display 104 to modulate the optical signal DSP. The control circuit 102 may also generate a brightness signal (e.g., B) received by the active dimmable lens 106a (e.g., received by the conductive planes 128). The brightness signal B may convey control data (e.g., a voltage) used to control the dimming of the active dimmable lens 106a. In embodiments where the conductive planes 128 are divided into segments, the brightness signal B may be implemented as multiple brightness signals B, one for each of the segments.

The control circuit 102 may implement an electronic control unit. The control circuit 102 is generally operational to generate the display information in the display signal D. The control circuit 102 may also be operational to generate and present the brightness information in the brightness signal B. In various embodiments, a separate control circuit 102 may be implemented for each console display 100a-100c. In some designs, a single control circuit 102 may be operational to simultaneously control two or more console displays 100a-100c.

The display 104 may implement a display panel that generates the optical signal DSP. The display 104 may be a color display or a black-and-white display. The display 104 may be mounted adjacent (or adjoining) the active dimmable lens 106a. The display 104 may be on an opposite side of the active dimmable lens 106a as the people. The display 104 is generally operational to change the images in the optical signal DSP in response to the display signal D. The changes generally include modulating the intensity and the color of the images. The modulated light may form the images in the optical signal DSP. In various embodiments, the display 104 may be implemented as a liquid crystal display (LCD), a thin-film transistor (TFT) liquid crystal display, an active-matrix liquid crystal display or a passive liquid crystal display with a backlighting source. Other display technologies may be implemented to meet the design criteria of a particular application.

The active dimmable lens 106a may implement a uniform type active dimmable lens or a segmented type active dimmable lens. A uniform type active dimmable lens 106a may be configured to uniformly control an optical transmission characteristic through the entire area of the active dimmable lens 106a. A segmented type active dimmable lens 106a may be configured to control the optical transmission characteristics through multiple segments (or areas) of the active dimmable lens 106a. The transmission characteristics of each segment may be controlled separately. By way of example, the active dimmable lens 106a of the console displays 100a-100c may be implemented in three segments, a segment for the console display 100a, another segment for the console display 100b and still another segment for the console display 100c. Therefore, the driver sitting on a shaded side of the vehicle may adjust the console display 100a to a preferred brightness level while the passenger sitting on a sunny side of the vehicle may adjust the console display 100c to a different brightness level. In various embodiments, the active dimmable lens 106a may ridged. In other embodiments, active dimmable lens 106a may be flexible to conform to contours of a console of the vehicle.

The cover layer 120 may be implemented as an optically transparent layer. The cover layer 120 may provide mechanical support for the active dimmable lens 106a. A first surface 121 of the cover layer 120 may face the people. A second surface 123 of the cover layer 120 may face the display 104. Protection of the lower layers of the active dimmable lens 106a may be provided by the cover layer 120. The cover layer 120 may be a glass layer or a plastic layer.

The anti-glare film 122 may be implemented as an anti-glare neutral density film. The anti-glare film 122 may be applied to the first surface 121 of the cover layer 120. The anti-glare film 122 is generally operational to reduce glare caused external light incident on the console display 100x.

The linear polarizer 124 may be attached to (adjoining) the second surface 123 of the cover layer 120. The linear polarizer 124 is generally operational to provide linear polarization of the optical signal DSP. When combined with the polarization caused by the active polarizer cell 126, the optical signal DSP may be dimmed to a lower intensity or brightened to a higher intensity based on the control data in the brightness signal B.

The active polarizer cell 126 may be attached to (adjoining) a side of the linear polarizer 124 opposite the cover layer 120. The active polarizer cell 126 may implement a uniform type active polarizer cell or a segmented type active polarizer cell. The active polarizer cell 126 is generally operational to establish a degree of polarization in the optical signal DSP.

The active polarizer cell 126 may be based on a guest-host dichroic dye liquid crystal system where the guest dye acts as the polarizing element. The dye may either be orthogonal or parallel to the host liquid crystal molecules and therefore the off state may be the polarizing state or the unpolarized state. For a key-off dead-front application, the off state may be the polarizing state. An amount (density) of the dye added to the liquid crystal mixture generally affects the cell operation. As an example, if the dye density is selected for a perpendicular (e.g., dye molecules are perpendicular to the surface, unpolarized state) transmission of 70%, when the polarized state is activated the transmission may drop to about 2%. Since the linear polarizer 124 may be part of the display 104, the active polarizer cell 126 may be the sole polarizing layer implemented in the active dimmable lens 106a to perform the dimming function.

The conductive planes 128 may be disposed within the active polarizer cell 126. The conductive planes 128 may implemented two counter opposing conductive planes. The conductive planes 128 may be implemented as Indium Tin Oxide conductive planes. In some configurations, the conductive planes 128 may be uniform conductive planes 128 spanning the cover layer 120. In other configurations, the conductive planes 128 may be implemented as multiple segments. Each segment may be individually controlled by a component of the brightness signal B. When a non-zero control voltage in the brightness signal B is applied across the conductive planes 128, a portion of the active polarizer cell 126 between the conductive planes 128 may establish a polarization of the optical signal DSP. A degree of the polarization may be controlled by an amplitude of the control voltage. While the conductive planes 128 are in the power-off condition, the polarization of light passing between the conductive planes 128 may be oriented relative to the polarization of the linear polarizer 124 to provide a maximum attenuation of the light (e.g., the optical signal DSP). While a maximum the control voltage is applied to the conductive planes 128, the resulting polarization may align with the polarization of the linear polarizer 124 and so provide minimum attenuation of the light. In various embodiments, the conductive planes 128 may include an optical fade region.

The opaque print 130 may be formed on a side of the active polarizer cell 126 opposite the linear polarizer 124. The opaque print 130 may be operational to block light leaking from the display 104. The opaque print 130 may also absorb incident light from inside the platform 90 to reduce visible reflections. In various embodiments, the opaque print 130 may be implemented as black paint or black ink. Edges of the opaque print 130 may include an optical faded region. The optical faded region may hide the outer periphery of the display 104.

A clear area 135 may be formed in the opaque print 130. The clear area 135 may be aligned with the display 104. A size of the clear area 135 may be smaller than a size of the display 104. The clear area 135 may allow the optical signal DSP to enter the active polarizer cell 126.

The adhesive film 134 may be applied in the clear area 135. In some embodiments, the adhesive film 134 may overlap onto the opaque print 130. The adhesive film 134 may be optically transparent to permit transmission of the optical signal DSP.

The anti-reflection film 132 may be attached to the active polarizer cell 126 by the adhesive film 134. The anti-reflection film 132 is generally operational to reduce reflections of the incident light from inside the platform 90 from being reflected back to the people.

FIG. 3 illustrates a schematic diagram of an implementation of a console display 100y in accordance with one or more embodiments. The console display 100y may be a variation of the console display 100x. In some embodiments, the console display 100y may be representative of the console displays 100a-100c. The console display 100y generally comprises the control circuit 102, the display 104 and an active dimmable lens 106b. The active dimmable lens 106b may be positioned before the display 104. The active dimmable lens 106b and the display 104 may be electrically connected to the control circuit 102.

The active dimmable lens 106b generally comprises the cover layer 120, the anti-glare film 122, an electronic tint cell (or active cell) 136, the two counter opposing conductive planes 128 within the electronic tint cell 136, the opaque print 130, the anti-reflection film 132, and the adhesive film 134. The brightness signal B may be received by the active dimmable lens 106b (e.g., received by the conductive planes 128). In embodiments where the conductive planes 128 are divided into segments, the brightness signal B may be implemented as multiple brightness signals B, one for each of the segments.

The electronic tint cell 136 may implement a uniform type electronic tint cell or a segmented type electronic tint cell. The electronic tint cell 136 is generally operational to change an opaqueness based on the control voltage in the brightness signal B. A helical rotation of light caused by the electronic tint cell 136 may also reduce reflections of the incident light bouncing off the display 104.

The conductive planes 128 may be disposed within the electronic tint cell 136. The conductive planes 128 may implemented two counter opposing conductive planes. In some configurations, the conductive planes 128 may be uniform conductive planes 128 spanning the cover layer 120. In other configurations, the conductive planes 128 may be implemented as multiple segments. Each segment may be individually controlled by a component of the brightness signal B. When a non-zero control voltage in the brightness signal B is applied across the conductive planes 128, a portion of the electronic tint cell 136 between the conductive planes 128 may establish an attenuation of the optical signal DSP. A degree of the attenuation may be controlled by an amplitude of the control voltage. While the conductive planes 128 are in the power-off condition, the attenuation of light passing between the conductive planes 128 may be a maximum attenuation of the light. While a maximum the control voltage is applied to the conductive planes 128, the resulting attenuation may be a minimum attenuation of the light.

An objective of the active dimmable lenses 106a and 106b may be to reduce reflections behind a front surface of the active dimmable lens 106a or 106b by using either the active polarizer cell 126 configuration or the electronic tint cell 136 configuration. By reducing the reflections after the anti-glare film 122, the display opening area appears black to the eye and may be similar in appearance to the surrounding black area.

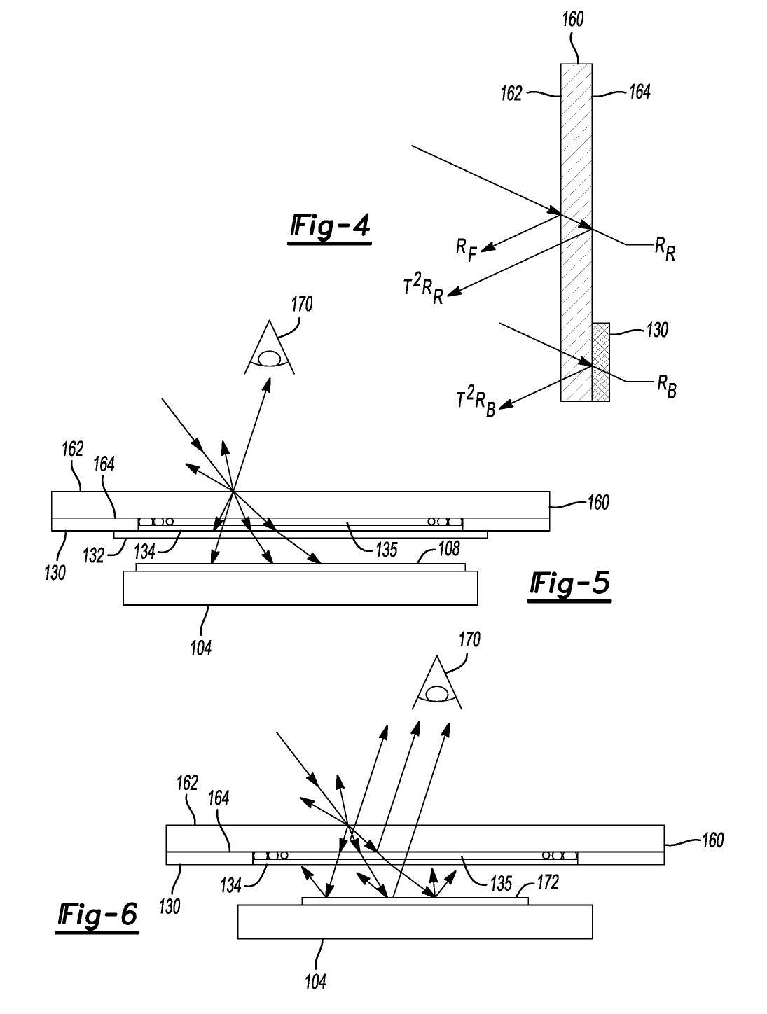

FIG. 4 illustrates a schematic diagram of a neutral density element reflection diagram in accordance with one or more embodiments. Historically, a common method to reduce the effect of reflections behind the front surface of the anti-glare film 122 is to use a static neutral density (ND) tinted lens or film with the highest possible transmission rate. Lower transmission lenses may do a better job of hiding the display opening but do so at the expense of display luminance or an amount of power consumed to obtain an appropriate luminance through the neutral density film. The lighter transmission of the neutral density films used for common seamless applications ranges from about 25% to 50%. As an example, give a rear reflection rate of R_{R} on a rear surface 164 of a film 160, the film 160 (e.g., the active dimmable lens 106a and/or the active dimmable lens 106b) may reduce the rear reflection by the square of a transmission rate (T) as shown in Equation 1 as follows:

R=T²×R_{R} (1)

Where, T may be a transmission rate of the film 160, R_{R} may be the reflection rate from the rear surface 164 of the film 160, and R may be a resulting rear reflection rate due to film transmission.

The contrast ratio (CR) between the opaque print 130 (e.g., black area) and the display aperture areas may be determined by Equation 2 as follows:

$$CR = \frac{{R}_{F} + {T}^{2} \times {R}_{R}}{{R}_{F} + {T}^{2} \times {R}_{B}} \qquad ( 2 )$$

Where RF may be a reflection rate from a front surface 162 of the film 160, R_{B} may be the reflection rate from the rear surface 164 of the film 160 in the area around the display opening that is printed with a black ink (e.g., the opaque print 130). The contrast ratio generally approaches unity as the transmission rate is decreased.

FIG. 5 illustrates a schematic diagram of the anti-reflection film 132 applied to the rear surface 164 of the film 160 in accordance with one or more embodiments. FIG. 6 illustrates a schematic diagram without the anti-reflection film 132 applied to the rear surface 164 of the film 160 in accordance with one or more embodiments. In order to reduce reflections and/or allow the use of a higher transmission rate type of the film 160, the anti-reflection film 132 may be applied to the rear surface 164 of the film 160 in the display opening area (e.g., the clear area 135) as shown in FIG. 5. In addition, the smooth anti-reflection film 108 may be applied to a front polarization surface of the display 104. A surface of the display 104 should be smooth in nature and not have the anti-glare polarizer layer 172 that would scatter the light back to the user as shown in FIG. 6.

An example of the anti-reflection film 132 may be a moth-eye (ME) film that is effective at off angle incident light conditions. The moth-eye film may also have a low anti-reflection quality. As an alternative, the display 104 may be optically bonded to the film 160 without the smooth anti-reflection film 108 and the anti-reflection film 132 being utilized. Such a configuration may be effective is because the smooth anti-reflection film 108 and the anti-reflection film 132 cancel the reflection of the incident light that is scattered by the anti-glare film 122. The front anti-glare film 122 may have one or more of the following attributes: a neutral density factor around 25% or greater; implemented as a combination of a polarization film and an optically bonded neutral density film; and implemented as a polarization film alone.

By way of example, the display 104 in FIG. 6 generally has the anti-glare polarizer layer 172 which scatters more light and makes the display aperture more visible to an eye 170 of the user (or person) than a smooth surface on the anti-reflection film 132 adjoining the display 104 in FIG. 5. By reducing the reflected scatter back to the eye 170 via the use of the smooth anti-reflection film 132 and the smooth anti-reflection film 108 (FIG. 5) and the use of the film 160 in front of the opaque print 130, the display aperture may become almost invisible because no reflection looks black to the eye 170 and becomes similar in appearance to the opaque print 130. An anti-glare film (e.g., the anti-glare film 122) on a front surface 162 (e.g., first surface 121) may also raise an ambient reflected level to the point that reduces the contrast ratio difference between the display aperture and black printed areas of the opaque print 130.

A secondary configuration may be utilized where no smooth anti-reflection film 108 and/or the anti-reflection film 132 is implemented and the front of the console display 100a-100c may be a smooth glossy treatment to reduce scratch susceptibility. The smooth glossy surface generally provides a decent seamless dead front look because the light from the sides may be specularly reflected around the eye and only light from the face is reflected back to the user when viewed perpendicularly. A benefit of using the moth-eye type of anti-reflection film 132 on the rear of the film 160 and the use of the smooth anti-reflective film 108 on the display polarizer surface may be ascertained by analyzing experimental data as shown in Table 1 with the use of a 22% neutral density element. A first configuration (e.g., ID no. 1) in Table 1 generally shows the following reflectance components from the anti-glare film 122 with the opaque print 130 (e.g., black screen print) on the back side of the film 160. A specular component included (SCI) may be approximately 4.63%, a specular component excluded (SCE) may be approximately 0.99%, and a difference of SCI-SCE may be approximately 3.64%. The difference SCI-SCE is generally a measure of the specular reflection component. Different anti-glare (AG) neutral density (ND) film, display configurations (e.g., hard coat (HC) displays, anti-reflective (AR) displays), moth-eye (ME) display apertures and reflectance measurements (using a Hunter Lab UltraScan Pro Spectrophotometer) may be provided in Table 1 as follows:

TABLE 1

| ID No. | SCI % | SCE % | SCI-SCE % |
|---|---|---|---|
| 1. AG ND Film + Black Screen Print | 4.63 | 0.99 | 3.64 |
| 2. AG ND Film Display | 4.95 | 1.05 | 3.9 |
| Aperture (no display) | | | |
| 3. AG ND Film + ME Display | 4.66 | 1.02 | 3.64 |
| Aperture (no display) | | | |
| 4. AG ND Film with AG Display | 5.21 | 1.17 | 4.04 |
| 5. AG ND Film with HC Display | 5.21 | 1.07 | 4.14 |
| 6. AG ND Film with AR Display | 5.02 | 1.08 | 3.94 |
| 7. AG ND Film + ME with AG Display | 4.96 | 1.16 | 3.8 |
| 8. AG ND Film + ME with HC Display | 4.96 | 1.08 | 3.88 |
| 9. AG ND Film + ME with AR Display | 4.73 | 1.09 | 3.64 |
| 10. AG ND Film Optically | 4.73 | 1.08 | 3.65 |
| Bonded to Display | | | |
| 11. AG Display alone | 5.38 | 2.23 | 3.15 |
| 12. HC Display alone | 5.32 | 0.09 | 5.23 |
| 13. AR Display alone | 1.33 | 0.09 | 1.24 |

A goal may be to make the display aperture area have the same reflection characteristics as the surrounding black screen print perimeter around the display aperture. The SCI reflection may be the total reflection while the SCE measures an amount of scattered light not at the specular (mirror) angle. Further information regarding reflectance measurement methods may be available in the Information Display Measurements Standard, version 1.03, Jun. 1, 2012, paragraphs 11.2.2 (SCI) and 11.3.2 (SCE), published by the International Committee For Display Metrology, Society For Information Display, Campbell, Calif., www.icdm-sid.org.

As an example, the ID no. 5 configuration of Table 1 (AG ND Film with HC Display) may be similar to the configuration shown in FIG. 3, and the aperture may be noticeable with an SCI=5.21%. By placing the moth-eye film on the back side of the active cell and changing the display polarizer surface to an anti-reflection coating (ID no. 9: AG ND Film+ME with AR Display), a significant improvement is generally obtained with an SCI=4.73%, which is much closer to the black area SCI of 4.63%. The use of the anti-reflection films generally allows performance close to a best possible optically bonded solution, as shown as ID no. 10 in Table 1.

The improvement in the contrast ratio, with a contrast ratio of unity as the best result, by using the smooth anti-reflection film 108 and the anti-reflection film 132 may be determined per Equations 3 and 4 as follows:

$$\begin{matrix}{CR}_{withoutAR} = \frac{5.21}{4.63} = 1.13 & ( 3 ) \\ {CR}_{withAR} = \frac{4.73}{4.63} = 1.02 & ( 4 )\end{matrix}$$

Another way to determine the benefit of utilizing anti-reflective films is to determine how much the neutral density film transmission may be increased thereby minimizing the display luminance criteria. The rear surface reflection component (R) without the anti-reflection film may be determined based on an index of refraction change from n₁ to n₂ using Equation 5 as follows:

$$R = {[ \frac{{n}_{2} - {n}_{1}}{{n}_{2} + {n}_{1}} ]}^{2} = {[ \frac{1 - 1.59}{1 + 1.59} ]}^{2} = 0.052 = 5.2 \% \qquad ( 5 )$$

Where n₁=1.59, and may be an index of refraction for a polycarbonate film, and n₂=1.0 may be an index of refraction for air.

When a moth-eye anti-reflective film is applied to the rear surface 164, the reflection is generally reduced to about 0.2%. Therefore, using the neutral density film transmission of 22% for the Table 1 neutral density film, the reflection difference (ΔR) between no anti-reflective film and with an anti-reflective film may be estimated using Equation 6 as follows:

$$Δ R = {( 0.22 )}^{2} {( \frac{1 - 1.59}{1 + 1.59} )}^{2} - {( 0.22 )}^{2} 0.002 = 0.24 \% \qquad ( 6 )$$

The value calculated per Equation 4 may be the same as the difference of configurations ID no. 2 (SCI=4.95%) and ID no. 3 (SCI=4.66%) in Table 1 as determined from Equation 5. The value determined from Equation 6 may be approximately the same as the experimentally measured value per Equation 7 and thereby confirming the reflectance calculation methodology. Equation 7 may be expressed as follows:

ΔR=4.95−4.66=0.29% (7)

The transmission improvement by using the anti-reflective films may be determined for similar performance to the no anti-reflective configuration using a hard coat display using Equation 8 as follows:

(0.22)²(0.052+0.0532)=T²(0.002+0.0133) (8)

Solving for T may yield Equation 9, which suggests that the neutral density film transmission may be increased from 22% to 58% with similar SCI performance. Equation 9 may be expressed as follows:

$$T = 0.22 \sqrt{\frac{0.052 + 0.0532}{0.002 + 0.0133 }} = 0.58 \qquad ( 9 )$$

With an actively controllable dimmable lens, the transmission rate may be adjusted to a lowest level depending on the ambient light conditions to maintain the best seamless appearance. As seen from Equation 6, lowering the transmission rate generally reduces the AR and improves the seamless appearance. Therefore, the display luminance may be operated at a maximum level and the lens transmission may be adjusted automatically by or manually through the control circuit 102 for comfortable visibility. Using a segmented Indium Tin Oxide (ITO) design for the conductive planes 128 the active polarizer cell 126 and/or the electronic tint cell 136, the clear areas 135 that define the display opening areas may be separated controlled via the control data in the brightness signal B. The tracking of the brightness signal components carrying the control data on the transparent conductive layers of ITO (or other suitable material) from the outer edge to the clear areas 135 may be achieved using standard techniques for liquid crystal cell designs.

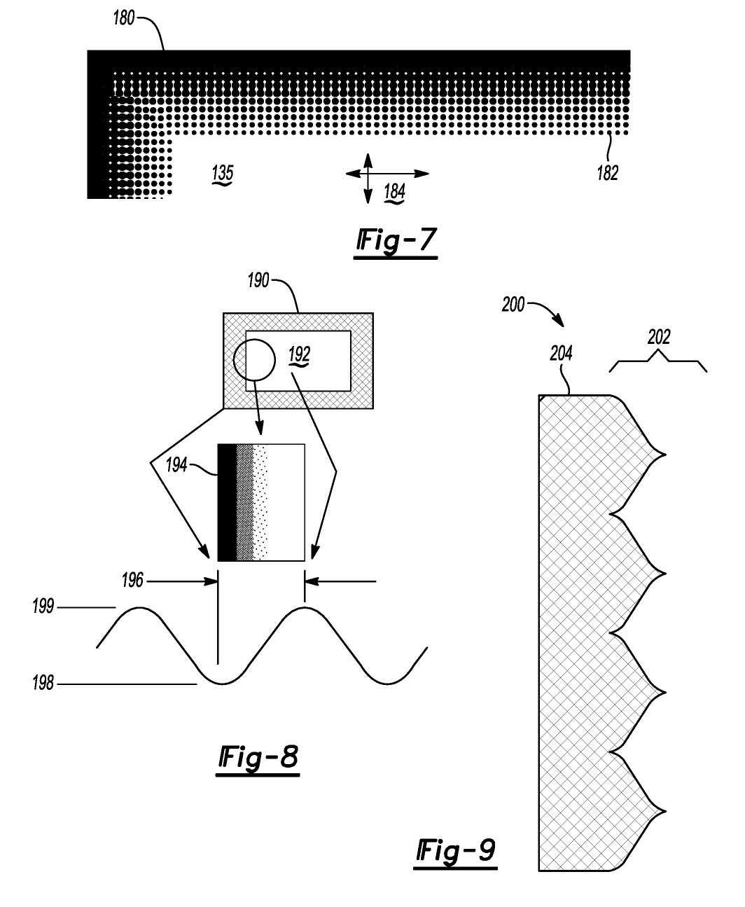

FIG. 7 illustrates a schematic diagram of a fade pattern 180 in a corner of the clear area 135 in accordance with one or more embodiments. In addition to the film and display configurations, another aspect that may be added to the solution is the fade pattern 180 surrounding the clear area 135 and intruding into the active area of the display 104. The fade pattern 180 may implement dot pattern comprising rows and columns of smaller and smaller dots 182. The fade pattern 180 may be only an example of a sinusoidal fade pattern. Other dot patterns that are not periodic and are more random in nature may be implemented to meet the design criteria of a particular application. A size 184 of the clear area 135 may be smaller than that of the display 104.

FIG. 8 illustrates a schematic diagram of a half-sinusoidal transmission fade pattern 190 in accordance with one or more embodiments. Half-sinusoidal fade patterns may be good fade patterns in nature. The half-sinusoidal transmission fade pattern 190 may be implemented as a halftone fade pattern or other types of fade technologies since a sinusoidal pattern has the lowest number of Fourier spatial frequencies. The lowest sinusoidal spatial frequency may work well due to a contrast sensitivity characteristics per the Contrast Sensitivity Function (CSF) of the human eye. The half-sinusoidal transmission fade pattern 190 may be developed by several means. For example, a combination of cosine and sine functions may be used to produce the half-sinusoidal fade pattern 190 along the edge of a display opening 192. Due to fabrication feature size capabilities, a pitch of the pattern may be made small and the half-sinusoidal transmission fade pattern 190 may appear as a continuous fade pattern 194 to the eye and the periodic structure would not be seen. Spatial frequencies below about 6 cycles per degree generally have a lower contrast sensitivity (e.g., are harder to see).

In various embodiments, a width 196 of the continuous fade pattern 194 may extend over a range of approximately 3 millimeters (mm) to approximately 7 mm (e.g., 5 mm). The continuous fade pattern 194 may range from a zero percent (e.g., no) transmission level 198 to a specified transmission level 199.

FIG. 9 illustrates a schematic diagram of a sinusoidal spatial fade pattern 200 in accordance with one or more embodiments. The sinusoidal spatial fade pattern 200 may include a spatially varying opaque area 202 adjoining a solid opaque area 204. The varying opaque area 202 may be spatially modulated in a series of sinusoidal patterns as shown. A contrast sensitivity function of the eye shows that spatial frequencies below approximately 6 cycles per degree generally have a lower contrast sensitivity (e.g., harder to see). Note that the solid opaque area 204 of the sinusoidal fade pattern 200 may also help to hide the display border in the on condition.

Selection a surface profile of the anti-glare film 122 generally affects light scattering, sparkle and image clarity performance. The use of different anti-glare films or coatings on the first (top) surface 121 may allow a fine tuning of the anti-glare features to minimize or remove the sparkle, with reflection considerations being warranted. Under the same light source and geometry, a lower gloss unit material may scatter the light more, which is good for specular “white shirt reflections”, but not for non-specular reflections from direct sunlight illumination. In general, more light scattering may help hide the display aperture area and may provide a more seamless appearance. A Bayer LM296 material is generally available in different gloss levels which has an effect on display sparkle due to the different surface profiles. Sparkle may be measured on a pixel-by-pixel basis using camera based photometry methods.

Optical modelling has indicated that sparkle may be associated with anti-glare feature size and the density of the features. A higher luminance may be seen where the anti-glare scattering feature does not exist in the display pixel area, whereas less sparkle may be seen due to a smaller feature size that results in a more uniform display pixel luminance.

Selection of a class of anti-glare applique film that does not blur the display image may be useful. For instance, the Bayer LM296 film generally has a modulation transfer function (MTF) characteristic that may be marginal. As an air gap distance between the film and the display image plane increases, the image may appear to become more defocused because the MTF function of the film is filtering out the higher spatial frequency components of the image.

On the other hand, another commercially available films which have smaller structures and better MTF performance may be used. The MTF of the smaller structure films may be greater than 0.6 at 5.8 cycles/mm, which is a minimum level that has been generally deemed acceptable. The anti-glare structure of the other films may be substantially insensitive to the 0 mm to 5 mm separation distances of the film from the image with regards to image clarity and therefore may allow working distances greater than 5 mm. The other films may also be characterized by lower sparkle due to the smaller anti-glare particle size. Good sparkle performance may be achieved when the feature size is substantially smaller than the display subpixel size.

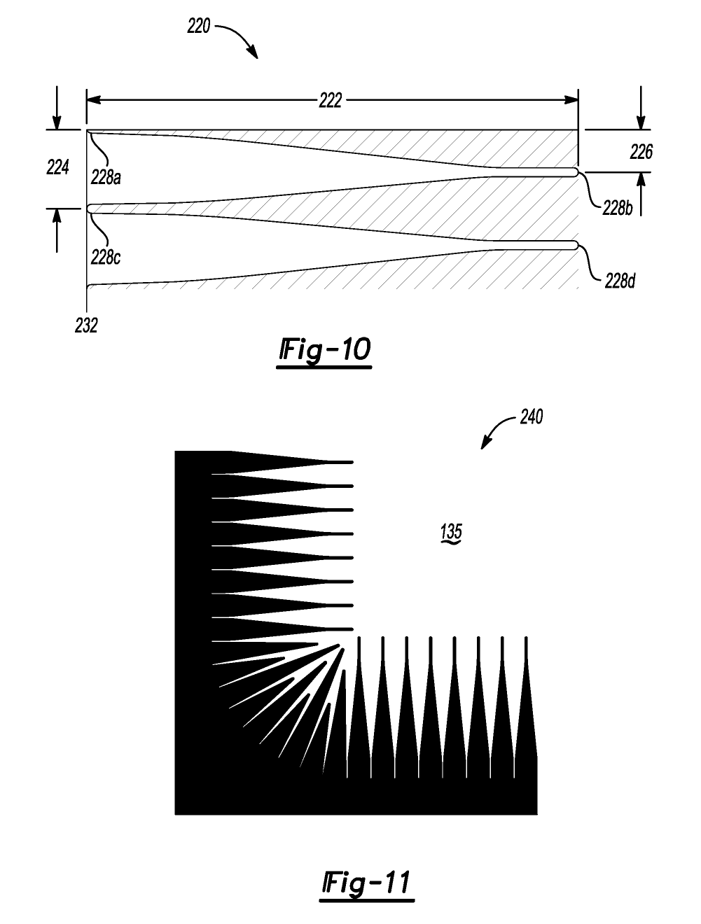

FIG. 10 illustrates a schematic diagram of a conductive plane fade pattern 220 in accordance with one or more embodiments. A dot pattern formed in the conductive planes 128 may be possible with the active polarizer cell 126 and/or the active electronic tint cell 136 by not electrically connecting the dots to the rest of the conductive planes 128 since the dots are in a polarized state when not electrically powered. Due to photolithography feature size capabilities, a pitch of the pattern in the conductive planes 128 may be made small (e.g., on the order of 30 micrometers). As such, the pattern may appear as a fade pattern to the eye and the periodic structure may not be seen.

Another technique to create a sinusoidal fade pattern in the conductive planes 128 is to use sine and cosine functions around a perimeter of the display opening. One or more segments of the conductive planes 128 around an active area edge 232 of the display 104 may be patterned with the conductive plane fade pattern 220, as illustrated. The sinusoidal transmission pattern generally has a length 222 that extends several millimeters (mm)(e.g., 2.5 mm) from an inactive (opaque) area into the active area of the display 104. A peak-to-peak separation 224 in the pattern along the active area edge 232 (e.g., from an end point 228a to an end point 228c) may be less than a millimeter (e.g., 0.4 mm). A peak-to-valley separation 226 in the pattern (e.g., from the end point 228a to an end point 228b) may also be less than a millimeter (e.g., 0.2 mm). Each end point 228a-228d may have a radii of about a dozen (e.g., 15) micrometers. The segments of conductive plane fade pattern 220 may be electrically isolated from the segment(s) of the conductive planes 128 in the clear area 135 by a small gap (e.g., 30 micrometers).

A spatial frequency associated with the transition of the conductive plane fade pattern 220 at a viewing distance of 1,000 mm is approximately 3.5 cycles/degree. Therefore, the contrast sensitivity may be reduced from the peak value of 6 cycles/degree. A larger fade-in length generally results in even less contrast sensitivity. In various embodiments, the end points 228a-228d may have a pitch of approximately several hundred (e.g., 400) micrometers. Therefore, the spatial frequency of the pattern 220 may be greater than 21 cycles/degree and the structure may not be visible since the contrast sensitivity is reduced by about a factor of 5.

FIG. 11 illustrates a schematic diagram of a corner fade patter 240 in accordance with one or more embodiments. Corners of the clear area 135 may involve spatial changes to provide continuity of the fade pattern. The sinusoidal fade patterns along the sides may transition into staggered triangular shapes around radiused corners. The staggered triangular shapes may extend into the clear area 135. The segments of the conductive planes 128 forming the fade patterns may be wired to remain in the polarization state (e.g., unpowered). Therefore, the fade patters 220 and 240 may appear dark at all times.

In addition to the fade patterns 180, 190, 194, 200, 220 and/or 240, the display aperture may be further hidden by displaying bright graphics near the display borders. For example, if high luminance white graphics are place near the border to lower the contrast sensitivity of the eye, a better performance may be achieved. Although the techniques as described may be particularly suitable for instrument cluster applications in vehicles, the techniques may also be applied to other display configurations such as center stack displays where the applique is replaced with a more rigid lens.

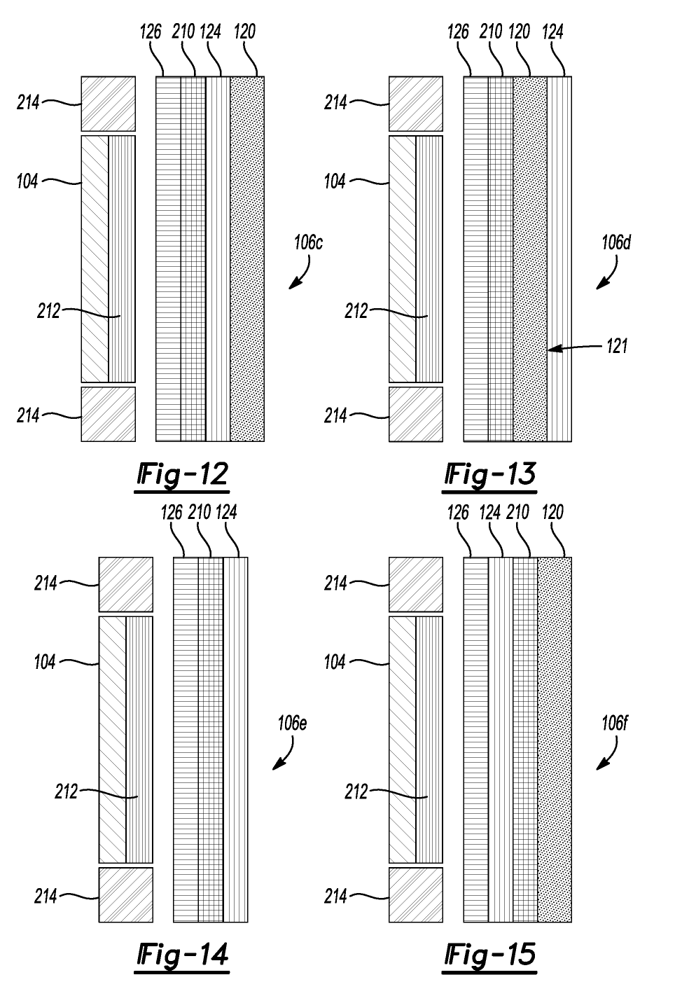

FIG. 12 illustrates a schematic diagram of an active dimmable lens 106c incorporating a touch sensor 210 in a baseline configuration in accordance with one or more embodiments. The active dimmable lens 106c generally comprises the anti-glare film 122, the linear polarizer 124, the active polarizer cell 126 and the touch sensor 210. The touch sensor 210 may be disposed between the linear polarizer 124 and the active polarizer cell 126. In various embodiments, a display linear polarizer 212 may be attached to the active side of the display 104. A bezel structure 214 may surround the display 104.

The display linear polarizer 212 may be part of the display 104 or a separate polarizer. The display linear polarizer 212 may be operational to polarize the optical signal DSP along a specified direction (e.g., vertical polarization). For example, the display linear polarizer 212 may be oriented to match the polarization of ordinary polarized sunglasses. While fully in the polarization state (e.g., while unpowered), the active polarizer cell 126 may polarize along a direction (e.g., horizontal polarization) orthogonal to that of the display linear polarizer 212. Likewise, the linear polarizer 124 may have an orthogonal polarization (e.g., vertical polarization) to the active polarizer cell 126 in the polarization state. Thus, while the console display 100a-100c is powered off, any external light entering the active dimmable lens 106c may be attenuated before reaching the display 104. Any light reflected by the display 104 may be attenuated again before leaving the active dimmable lens 106c resulting in a dark appearance.

The touch sensor 210 is generally located in front of the active polarizer cell 126 in the optical stack. Since the active polarizer cell 126 has the two counter opposing conductive planes 128 (FIGS. 2 and 3), the conductive planes 128 may short out E-fields of the capacitive-type touch sensor 210 if the active polarizer cell 126 were placed between the touch sensor 210 and the fingers of the users (e.g., in “front” of the touch sensor 210). In various embodiments, the linear polarizer 124 may be placed in front of the touch sensor 210 to reduce the reflections from the touch sensor 210. In other embodiments, the linear polarizer 124 may be placed behind the touch sensor 210.

Transmittance of the active polarizer cell 126 is generally divided between a high display transmission rate (e.g., about 87%) in the non-polarized state and a low display transmission rate (e.g., about 15%) would result in the polarized state. A gradual and continuous change in the transmission rate generally exists between the high display transmission rate the low display transmission rate. A doping level of the active polarizer cell 126 may be adjusted to affect transmissions in the high state and in the low state. Intermediates dimming states may be accomplished and therefore the active polarizer cell 126 is not restricted to bimodal operational states such as may occur with cholesteric or ferroelectric liquid crystal configurations.

Many other configurations of the active dimmable lenses 106a-106c may be implemented with the active polarizer cell 126 and the touch sensor 210 as shown in FIGS. 13-19. Although all possible configurations are not shown, a feature in common to the configurations is that the touch sensor 210 may be placed in front of the active polarizer cell 126. In addition, more than one linear polarizer (e.g., 124 and 212) may be implemented in the optical stack. Components of the optical stack may be optically bonded together or have air gaps in between. If the air gaps are used, an option exists to utilized engineered air gaps having anti-reflection coatings and/or films in the optical stack.

FIG. 13 illustrates a schematic diagram of an active dimmable lens 106d with the linear polarizer 124 on the first surface 121 of the cover layer 120 in accordance with one or more embodiments.

FIG. 14 illustrates a schematic diagram of an active dimmable lens 106e with no cover layer 120 in accordance with one or more embodiments.

FIG. 15 illustrates a schematic diagram of an active dimmable lens 106f with the linear polarizer 124 behind the touch sensor 210 in accordance with one or more embodiments.

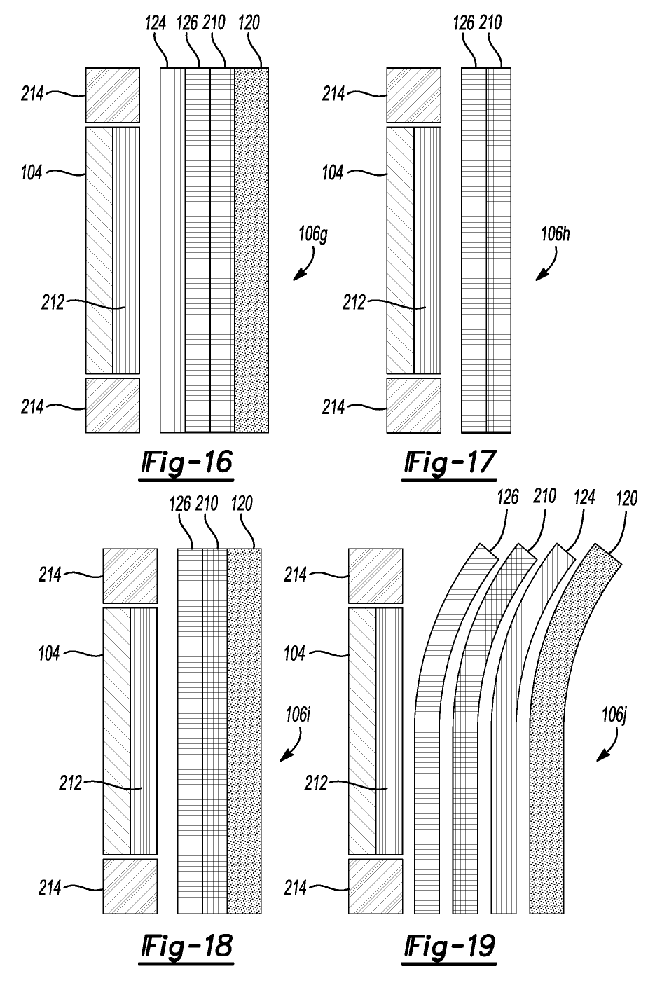

FIG. 16 illustrates a schematic diagram of an active dimmable lens 106g with the linear polarizer 124 between the active polarizer 126 and the display 104 in accordance with one or more embodiments.

FIG. 17 illustrates a schematic diagram of an active dimmable lens 106h with no linear polarizer 124 and no cover layer 120 in accordance with one or more embodiments.

FIG. 18 illustrates a schematic diagram of an active dimmable lens 106i with no linear polarizer 124 in accordance with one or more embodiments. In the active dimmable lens 106i, the active polarizer cell 126 and the display linear polarizer 212 may work together to provide the dimming function.

FIG. 19 illustrates a schematic diagram of an active dimmable lens 106j with a shaped configuration in accordance with one or more embodiments. Since the active polarizer cell 126 may be constructed with flexible substrates, the active polarizer cell 126 may be laminated to curves cover layers 120 and/or other surfaces such as a curved console display.

The active dimmable lenses 106a-106j generally implement a structure based on segmented liquid crystal cell designs. The active dimmable lenses 106a-106j may provide quality seamless automotive instrument cluster performance. Several concepts may be utilized in the active dimmable lenses 106a-106j. The use of the segmented liquid crystal cell may allow the transmission of the display opening areas to be adjusted dynamically to the level suitable for display visibility while maintain a seamless appearance. The use of the anti-glare film 122 with anti-reflection film 132 over the backside of the display opening and the smooth anti-reflective film 108 on a front polarizer surface of the display 104 may help achieve the seamless appearance. The use of a fade pattern 180, 190 and/or 200 applied to the active cells around the border of the display aperture and extending over the active area, where the fade pattern is essentially half sinusoidal in nature and has a user spatial frequency less than 6 cycles/degree may also help provide the seamless appearance. The use of the anti-glare film 122 with small feature sizes generally provides suitable modulate transfer function and sparkle characteristics. Furthermore, the use of bright display symbology/graphics near the border to change the contrast sensitivity of the eye may cause the display aperture border to become more difficult to detect.

The aspects disclosed herein generally resolve several issues. Use of the segmented active polarizer cell 126 or the electronic tint cell 136 may actively control the transmission of the display opening clear area 135. The active dimmable lenses 106a-106j may reduce reflections in the display aperture to mimic the black reflection characteristics in the surrounding non-display area. Use a sinusoidal fade pattern may aid in hiding the display opening. Selection of an anti-glare surface with good light scattering, low sparkle, and good image clarity characteristics generally improves overall performance. Use of white graphics around the display aperture perimeter may help hide display openings.

Thus, the foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A display system, comprising:
a display configured to generate an optical signal;
a cover layer covering the display, wherein
the cover layer has a first surface and a second surface opposing the first surface, and
the cover layer is configured to pass the optical signal through the second surface and out of the first surface;
an active cell adjacent to the second surface of the cover layer, wherein
the active cell includes a plurality of conductive planes, and
the active cell is configured to vary a transmission of the optical signal through the active cell in response to a brightness signal applied to the plurality of conductive planes;
an opaque print adjacent the active cell opposite the cover layer, wherein
the opaque print has a clear area aligned with the display, and
the clear area has a size smaller than the display;
an adhesive film adjacent to the active cell opposite the cover layer, wherein
the adhesive film is aligned with the clear area, and
the adhesive film is transparent to transmit the optical signal; and
an anti-reflective film attached to the adhesive film and configured to receive the optical signal from the display.

2. The display system of claim 1, wherein
the active cell comprises an electronic tint cell, and
the transmission is an optical attenuation of the optical signal received from the display.

3. The display system of claim 1, wherein
the active cell comprises an active polarizer cell, and
the transmission is a degree of optical polarization.

4. The display system of claim 3, further comprising a linear polarizer disposed between the cover layer and the active polarizer cell, wherein
the linear polarizer is configured to attenuate the optical signal in response to the degree of optical polarization in the active polarizer cell.

5. The display system of claim 1, further comprising a touch sensor disposed on a side of the active cell opposite the display.

6. The display system of claim 1, wherein
the opaque print includes an opaque area surrounding the clear area, and
the opaque print includes a fade pattern between the opaque area and the clear area.

7. The display system of claim 1, wherein
the plurality of conductive planes in the active cell include a segment forming a fade pattern that extends into the clear area.

8. The display system of claim 7, wherein
the fade pattern comprises a spatial pattern, and
the segment of the plurality of conductive planes forming the fade pattern is in a polarizing state while electrical power is off.

9. An active dimmable lens, comprising:
a cover layer configured to cover a plurality of displays, wherein
the cover layer has a first surface and a second surface opposing the first surface, and
a plurality of optical signals generated by the plurality of displays enter the cover layer through the second surface and exit through the first surface;
an active cell adjacent to the second surface of the cover layer, wherein
the active cell includes a plurality of conductive planes,
the conductive planes include a plurality of segments,
the plurality of segments are aligned with the plurality of displays, and
a plurality of transmissions of the plurality of optical signals through the plurality of segments are independently variable in response to a plurality of brightness signals applied to the plurality of segments;
an opaque print adjacent the active cell on the side opposite the cover layer, wherein
the opaque print has a plurality of clear areas aligned with the plurality of displays, and
the plurality of clear areas have a plurality of sizes smaller than the plurality of displays;
a plurality of adhesive films adjacent to the active cell opposite the cover layer, wherein
the plurality of adhesive films are aligned with the plurality of clear areas, and
the plurality of adhesive films are transparent to the plurality of optical signals; and
a plurality of anti-reflective films attached to the plurality of adhesive films and configured to receive the plurality of optical signals from the plurality of displays.

10. The active dimmable lens of claim 9, wherein
the active cell comprises an electronic tint cell, and
the plurality of transmissions are a plurality of optical attenuations of the plurality of optical signals received from the plurality of displays.

11. The active dimmable lens of claim 9, wherein
the active cell comprises an active polarizer cell, and
the plurality of transmissions are a plurality of degrees of optical polarization.

12. The active dimmable lens of claim 11, further comprising a linear polarizer disposed between the cover layer and the active polarizer cell, wherein
the plurality of optical signals are attenuated by the linear polarizer in response to the plurality of degrees of optical polarization created in the active polarizer cell.

13. The active dimmable lens of claim 9, wherein
the opaque print includes a fade pattern that extends into the plurality of clear areas.

14. The active dimmable lens of claim 9, further comprising a touch sensor disposed on a side of the active cell opposite the plurality of displays.

15. The active dimmable lens of claim 9, wherein
the plurality of displays comprise an instrument cluster display, a center console display and a passenger display.

16. An active dimmable lens, comprising:
a cover layer configured to cover a display, wherein
the cover layer has a first surface and a second surface opposing the first surface,
the display is configured to generate an optical signal, and
the cover layer is configured to pass the optical signal through the second surface and out of the first surface;
an active cell adjacent to the second surface of the cover layer, wherein
the active cell includes a plurality of conductive planes, and
the active cell is configured to vary a transmission of the optical signal through the active cell in response to a brightness signal applied to the plurality of conductive planes;
a touch sensor disposed on a side of the active cell opposite the display;
an opaque print adjacent the active cell on the side opposite the cover layer, wherein
the opaque print has a clear area aligned with the display, and
the clear area has a size smaller than the display;
an adhesive film adjacent to the active cell opposite the cover layer, wherein
the adhesive film is aligned with the clear area, and
the adhesive film is optically transparent to transmit the optical signal through the adhesive film; and
an anti-reflective film attached to the adhesive film and configured to receive the optical signal from the display.

17. The active dimmable lens of claim 16, further comprising a linear polarizer configured to polarize the optical signal.

18. The active dimmable lens of claim 17, wherein
the linear polarizer and the touch sensor are disposed on a same side of the active cell.

19. The active dimmable lens of claim 17, wherein
the linear polarizer and the touch sensor are disposed on opposite sides of the active cell.

20. The active dimmable lens of claim 16, further comprising a display linear polarizer disposed on the display and configured to polarize the optical signal orthogonal to a polarization of the active cell.
